(19) United States
(12) Patent Application Publication
(10) Pub. No.: US 2015/0308338 A1
(43) Pub. Date: Oct. 29, 2015

(54) GAS TURBINE INLET HAVING INTEGRATED COILS AND MIST REDUCING VANES

(71) Applicant: General Electric Company, Schenectady, NY (US)

(72) Inventors: Yongjiang Hao, Shanghai (CN); Doug Scott Byrd, Greenville, SC (US); Brad Aaron Kippel, Greenville, SC (US); Jianmin Zhang, Greenville, SC (US)

(21) Appl. No.: 14/117,661

(22) PCT Filed: Jan. 11, 2013
(86) PCT No.: PCT/CN2013/070351

§ 371 Date: Nov. 14, 2013

(51) Int. Cl. F02C 7/12; F01D 25/32

(52) U.S. Cl. CPC F02C 7/12; F01D 25/32

(57) ABSTRACT

An integrated coil and fin system in a gas turbine inlet. The integrated system includes at least one wavy, non-planar, fin integrated with at least one heating/cooling coil, wherein the at least one coil is configured to heat or cool air moving through the gas turbine inlet, and wherein the at least one non-planar fin is configured to remove moisture in the air moving through the gas turbine inlet. In one embodiment, at least one hook can be included at an end or along a length of at least one non-planar fin.

### FIELD OF THE INVENTION

This invention relates generally to gas turbines, and more particularly, to a gas turbine inlet having integrated coils and mist reducing fins/vanes.

### BACKGROUND OF THE INVENTION

As air moves into gas turbines through an inlet, it is often desirable to filter that air and/or remove moisture from that air. In addition, it is often desirable to either heat or cool the air as it moves through the inlet into the turbine. Conventionally, an inlet filter housing is used to house heating and/or cooling coils to heat/cool the air as desired, as well as filters to filter the air as necessary. In addition, wavy vanes have been used within the filter housing that force the air through a tortuous path, allowing the heavier moisture droplets to drop down due to inertia when the water droplets impact the vanes.

### BRIEF DESCRIPTION OF THE INVENTION

An integrated coil and fin system in a gas turbine inlet is disclosed. The integrated system includes at least one wavy, i.e., non-planar, fin integrated with at least one heating/cooling coil, wherein the at least one coil is configured to heat or cool air moving through the gas turbine inlet, and wherein the at least one wavy fin is configured to trap moisture in the air moving through the gas turbine inlet. In one embodiment, at least one hook can be included at an end or along a length of at least one wavy fin.

A first aspect of the disclosure provides an integrated coil and fin system for use in a gas turbine inlet, the integrated coil and vane system comprising: at least one non-planar fin attached to at least one coil, wherein the at least one coil is configured to heat or cool air moving through the gas turbine inlet, and wherein the at least one non-planar fin is configured to remove moisture in the air moving through the gas turbine inlet.

A second aspect of the disclosure provides a gas turbine inlet comprising: a filter housing including an integrated coil and fin system, the system including: at least one non-planar fin attached to at least one coil, wherein the at least one coil is configured to heat or cool air moving through the gas turbine inlet, and wherein the at least one non-planar fin is configured to remove moisture in the air moving through the gas turbine inlet; and an inlet duct fluidly connected to the housing and to a gas turbine.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

The above and other aspects, features and advantages of the invention will be better understood by reading the following more particular description of the invention in conjunction with the accompanying drawings.

FIG. 1 shows an isometric view of a conventional fin-tube heat exchanger;

FIG. 2 shows a cross-sectional schematic view of an inlet filter housing for a gas turbine, including a system according to an embodiment of the invention;

FIG. 3 shows a top view of a system having integrated coils and mist reducing vanes in a gas turbine inlet according to an embodiment of the invention;

FIG. 4 shows a close-up cross-sectional view of a hook at an end of an integrated coil in a system according to an embodiment of the invention;

FIGS. 5-7 show respective top views of various configurations of systems having integrated coils and mist eliminating vanes in a gas turbine inlet according to embodiments of the invention;

FIG. 8 shows a cross-sectional view of the interface between coils and vanes/fins according to an embodiment of the invention;

FIG. 9 shows an isometric partial view of a fin/vane according to an embodiment of the invention; and

FIG. 10 shows a top view of a system having integrated coils and mist eliminating vanes in a gas turbine inlet according to another embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of the invention include integrated heating/cooling coils and vane/fin type mist reducers for gas turbine inlets. A fin-tube integrated heat exchanger 1 as known in the art is shown in FIG. 1. Fin-tube integrated heat exchanger 1 includes a plurality of flat, planar, fins 3, arranged parallel to each other, and a plurality of heat transfer coils 2 penetrating fins 3. Air A flows through fins 3, and heating/cooling liquid or gas B flows through coils 2.

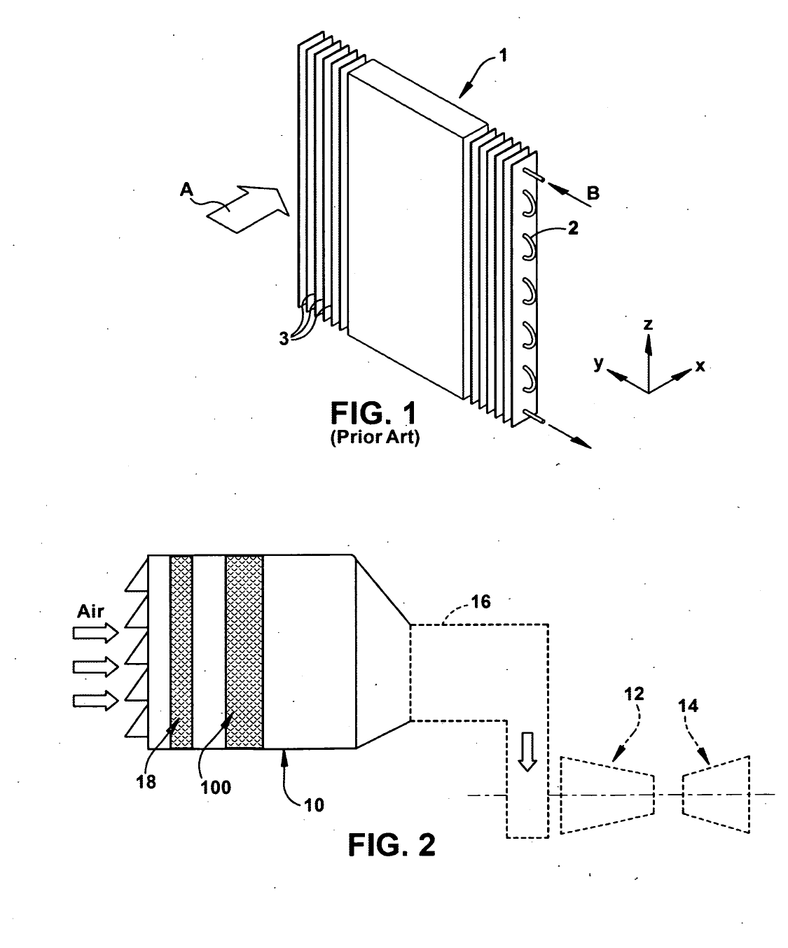

Referring to FIG. 2, a cross-sectional drawing of an air inlet housing 10 having system 100 according to an embodiment of the invention is shown. As is known in the art, air inlet housing 10 is connected to a compressor 12 and a turbine 14 via an inlet duct 16. It is understood that housing 10 typically includes at least one filter element 18 that filters air as it flows through inlet housing 10 as shown by the arrows in FIG. 2. According to an embodiment of this invention, housing 10 further includes at least one system 100, comprising vanes/fins integrated with heating or cooling coils, as discussed herein. Although system 100 is shown in FIG. 2 as positioned downstream (with respect to the air flow through inlet 10) from filter 18, it is understood that system 100 could also be positioned upstream from filter 18, or positioned between two separate filters 18.

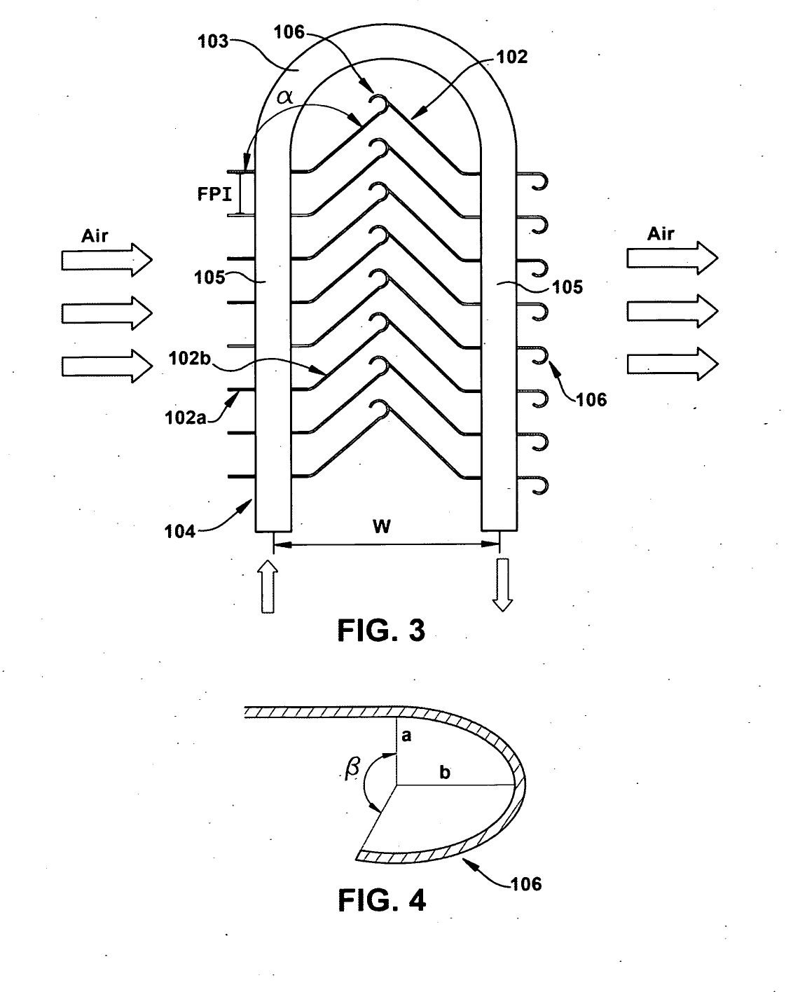

Turning to FIG. 3, a top view of one embodiment of a system 100 in inlet housing 10 (FIG. 2) of gas turbine 14 (FIG. 2) is shown. As shown in FIG. 3, a plurality of wavy fins 102 (also referred to as vanes) are integrated with at least one heating or cooling coil 104. Coils 104 are configured to heat or cool air moving through the gas turbine inlet housing 10, and wavy fins 102 are non-planar vanes configured to provide a tortuous path for the air moving through gas turbine inlet housing 10 such that moisture, i.e., mist, in the air will impact wavy fins 102. As is known in the art, coils 104 comprise hollow coils configured for fluid to flow therethrough, for example, hot fluid or cold fluid.

Any number of wavy fins 102 can be included, and each wavy fin 102 can be spaced apart from adjacent wavy fins 102 as desired. This distance between fins is referred to as “fins per inch” (FPI) and is shown in FIG. 3. The smaller the distance between adjacent fins 102, the higher the heating efficiency will be for air moving through system 100, as there will be more surface area for the air moving through to contact.

Wavy fins 102 can be as wavy as desired, i.e., as angled with respect to the air flow through system 100 as desired. As shown in FIG. 3, fins 102 have a first portion 102a, substantially parallel to the air flow, and a second portion 102b, angled with respect to first portion 102a at an angle, α. It is understood that first and second portions 102a, 102b, can be repeated as needed, such that a fin 102 can include as many peaks or turns as desired. Generally, the wavier the fins 102 (i.e., the more turns, or the smaller the angles between portions), the more aggressive the moisture removal will be. In other words, if there is significant moisture to remove, a smaller angle, α, would be preferred, but a smaller angle will also result in a higher pressure drop across system 100. In one embodiment, angle, α, could be approximately 90 degrees to approximately 180 degrees. A smaller angle, α, will also lead to a shorter distance between coils 104, noted as distance, W, in FIG. 3. This shorter distance, W, results in a more compact filter housing than conventional housings since there is not as much space needed between coils 104.

The wavier fins 102, i.e., the more turns included or the smaller the angle between portions, the more tortuous the path the air will need to take to travel through the housing, and therefore the more the air will impact the fins 102. As such, moisture drops will have more opportunities to impact fins 102, causing more moisture drops to fall out of the air stream. In addition, wavy fins 102 act to increase velocity of air moving through inlet.

As shown in FIG. 3, wavy fins 102 can further include at least one hook 106. Hooks 106 act to trap moisture as air moves through the inlet as indicated by the arrows in FIG. 3. Moisture drops will be caught by hooks 106, and form a water film. As water accumulates, gravity will cause the water to flow down. The water that flows down can be caught by a reservoir (not shown), e.g., a drain pan, at the bottom of coils 104.

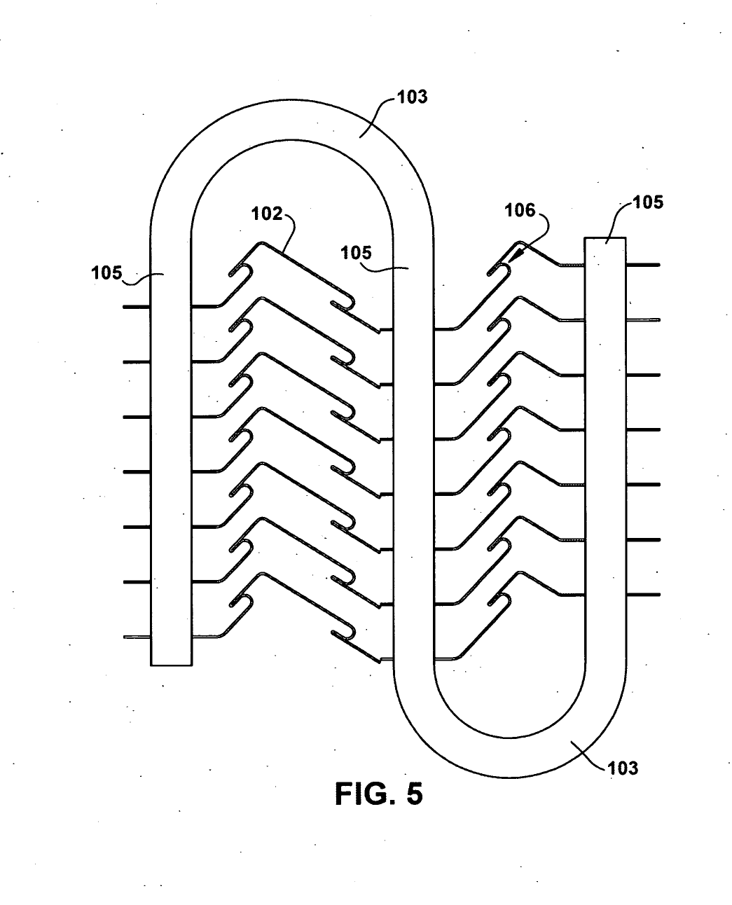

Hooks 106 can be any shape as desired, for example, as shown in the exploded view in FIG. 4, hooks 106 can be a partial ellipse shape. As shown in FIG. 4, hooks 106 can comprise a partial ellipse with a minor semi-axis, a, and a major semi-axis, b, with the ellipse being cut off at an angle, β. In one embodiment, the ratio of major to minor semi-axes, or a/b, can be approximately 1 to 10, and angle, β, can be approximately from 90 degrees to 270 degrees. It is understood that any other shape can be used in accordance with the invention, and hooks 106 are not necessarily rounded, but could have rectangular angles or sharp angles. Hooks 106 can be formed by any known process, for example, a hook 106 can be die formed on wavy fins 102, or an end of wave fins 102 could be bent to form hooks 106.

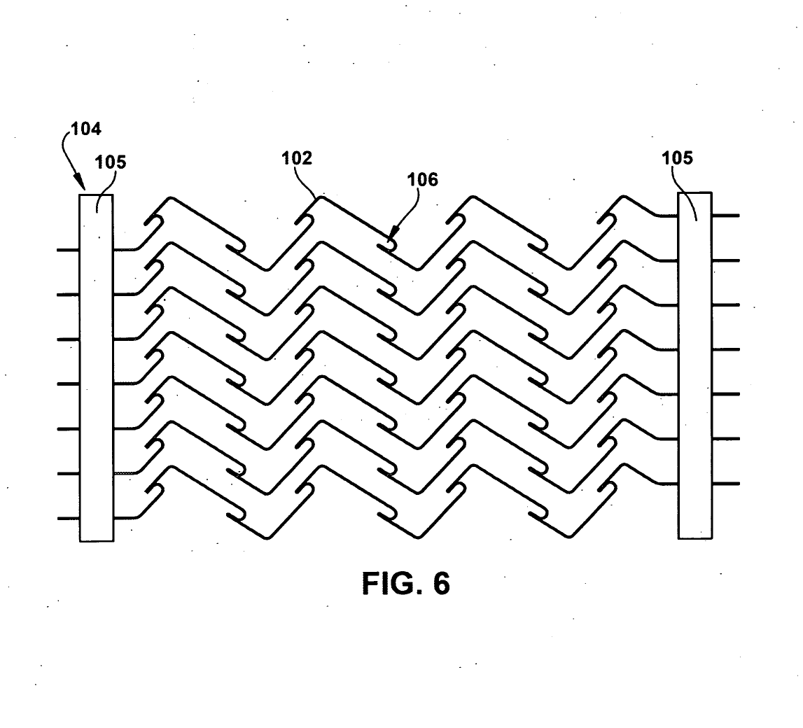

Hooks 106 can be provided at any position along wavy fins 102, for example, hooks 106 can be included at each turn in wavy fins 102, or can be included in the middle of a wavy fin 102. Wavy fins 102 can also be one continuous element with hooks 106 included along its length (as in FIGS. 5 and 6), or wavy fins 102 can comprise a series of separate elements, each with a hook at its end, with each element positioned end to end (as in FIG. 3). It is understood that any number of hooks 106 can be included along wavy fins 102, and it is understood that not every wavy fin 102 need include hooks 106. The more hooks 106, the more aggressive the moisture reduction. Hooks can be positioned on alternating sides of wavy fins 102 as shown in the figures, or all along one side of wavy fins 102. As long as hooks 106 have an open side of the hook facing the air flow, moisture drops in the air will impact hooks 106 as the air travels through the inlet, and therefore the moisture drops will be trapped by hooks 106 and then will drop down due to gravity.

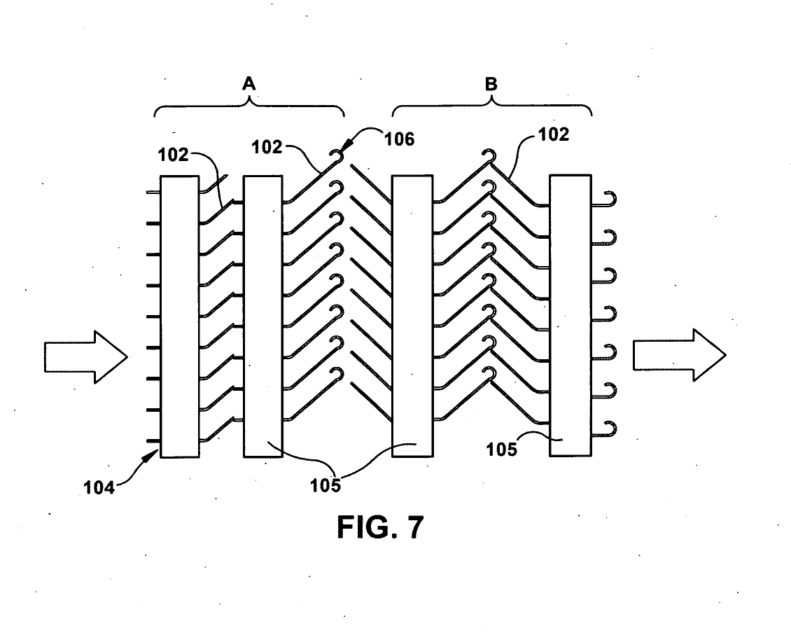

It is understood that heating/cooling coils 104 can comprise any known type of heating or cooling coils configured to heat or cool air as it passes through system 100. For example, a heating coil 104 can have hot water or hot steam or hot air passing through it, so that coil 104 is hot, and then as cold and wet air moves through the inlet, and passes over coils 104, it is heated, and then warm and dry air is outputted. Use of heating coils 104 will also serve to maintain wavy fins 102 at an elevated temperature level above freezing point, thereby preventing ice forming under freezing ambient conditions. It is also understood that although not illustrated in the top down views shown in FIGS. 3-7, coils 104 can be connected through several elevations, i.e., horizontal planes, as shown in FIG. 1, or can be all within one horizontal plane.

Additional configurations of wavy fins 102 and hooks 106 are shown in FIGS. 5-7. For example, as shown in FIGS. 5 and 6, coils 104 can have a plurality of turns 103, referred to as multi-pass coils, resulting in multiple parallel sections of coils 104 (referred to as parallel “rows” 105 as shown in the figures). In FIG. 5, multiple segments of wavy fins 102 are attached to three rows 105 of coils 104. In FIG. 6, multiple segments of wavy fins 102 are attached to two rows 105 of coils 104.

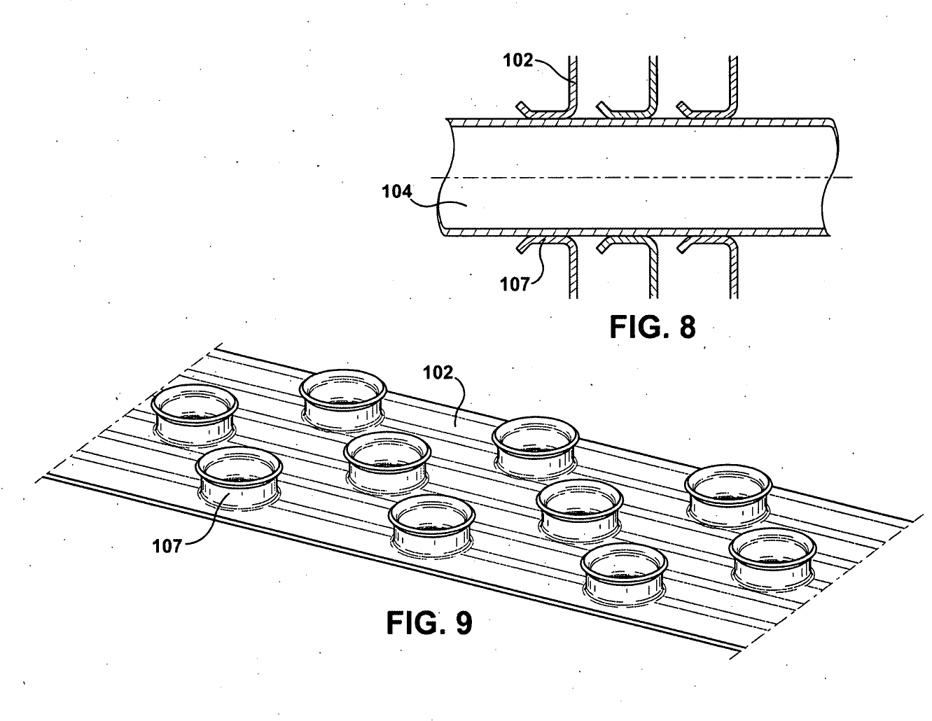

The systems disclosed herein are referred to as “integrated” systems because coils 104 are integrated with wavy fins 102. In other words, wavy fins 102 are positioned between and around coils 104 as illustrated in FIGS. 2 and 8. For example, FIG. 8 shows a cross-sectional view of an interface between a coil 104 and fins 102. As shown in FIG. 8, wavy fins 102 can include a plurality of holes each with a collar 107, and coils 104 can penetrate through collars 107. Coils 104 can then be hydraulically expanded to form a bond to collars 107. In another example, ultrasonic soldering can be used to attach fins 102 to coils 104, or other types of welding/brazing methods can be used. FIG. 9 shows an isometric view of a wavy fin 102 including a plurality of holes and collars 107.

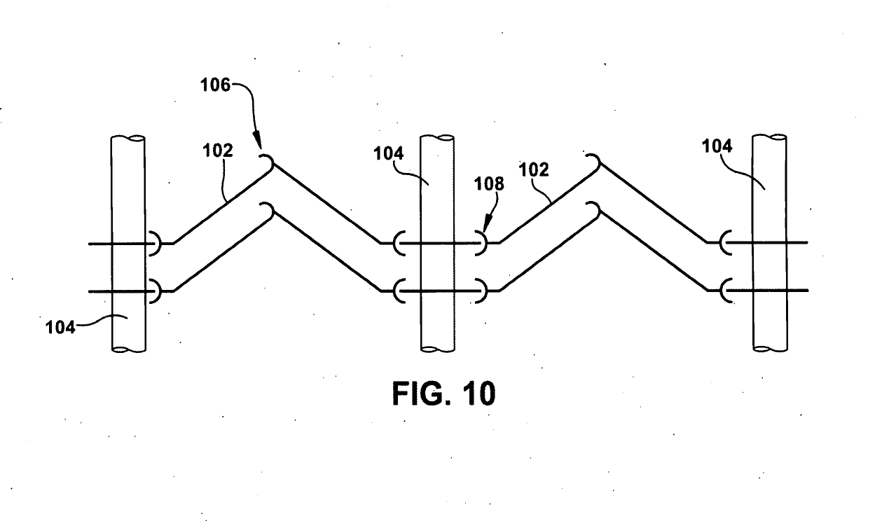

It is understood that embodiments of the invention can include using conventional flat, planar, fins as well as wavy fins 102. For example, as shown in FIG. 10, conventional flat, planar, fins can be used proximate to coils 104 (i.e., coils 104 can penetrate through, and be bonded to, flat fins) while wavy fins 102 can be used between coils 104. In one example, a portion 108 of wavy fins 102 can be shaped to matingly engage flat fins attached to coils 104.

The invention involves integrating heating/cooling coils 104 with wavy fins 102 that act as mist reducers/eliminators for gas turbine inlet applications. Wavy fins 102 can be wavier (i.e., smaller a angles and more turns) and have extra hooks 106 if aggressive moisture removal is desired, or less hooks 106, and less wavy (i.e., higher a angles and less turns) if less airflow pressure drop is desired. It is also understood that system 100 can include different portions that accomplish different objectives. For example, as shown in FIG. 6, system 100 can be viewed as two portions, A, B. Portion A, the upstream portion, can include inactive coils 104, i.e., coils with no heating/cooling flowing through them. While no heating/cooling is performed in portion A, wavy fins 102 and hooks 106 can be provided to remove moisture from the air. It is understood that any configuration of wavy fins 102 and hooks 106 as discussed herein could be included in portion A, depending on the level of moisture removal desired. It is also understood that inactive coils 104 are provided to act as support structures for wavy fins 102, but any other type of support structure could be used, as coils 104 are not necessary in the solely moisture removing section Portion A. Portion B can be configured as discussed herein to act as both heating and moisture removing. For example, coils 104 can be active, i.e., have heating fluid flowing through them, and wavy fins 102 and hooks 106 can be included to remove any additional moisture from the air. Because a substantial amount of the moisture in the air is removed as the air flows through portion A, the air moving through portion B is drier air, and is therefore easier to heat, resulting in a more efficient system and energy savings.

The moisture reducing vanes/fins 102 have a wavy fin design that act as both heat transfer and moisture reducing vanes. As a result, enhanced heat transfer can reduce the number of heating coils 104 and/or fins/vanes 102, and reduce the airflow pressure drop with respect to a pressure drop that would be found in a conventional vane-type moisture separator plus a heating/cooling coil. In addition, the cross section of heating coils 104 can be small enough that it can remove a potential downstream coalescing filtration stage used in a conventional filter housing. Therefore, system 100 as described herein can decrease a total pressure drop compared with that of a system including vanes, heating coils and coalescing filtration, therefore, system 100 can raise turbine efficiency and power output.

The apparatus and method of the present disclosure is not limited to any one particular gas turbine, turbine, power generation system or other system, and may be used with other power generation systems and/or systems (e.g., combined cycle, simple cycle, nuclear reactor, etc.). Additionally, the apparatus of the present invention may be used with other systems not described herein that may benefit from the increased operational range, efficiency, durability and reliability of the apparatus described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated coil and fin system for use in a gas turbine inlet, the integrated coil and vane system comprising:
at least one non-planar fin attached to at least one coil, wherein the at least one coil is configured to heat or cool air moving through the gas turbine inlet, and wherein the at least one non-planar fin is configured to remove moisture in the air moving through the gas turbine inlet.

2. The integrated coil and fin system of claim 1, wherein at least one non-planar fin includes at least one hook.

3. The integrated coil and fin system of claim 2, wherein the at least one hook comprises an approximate half-ellipse shape.

4. The integrated coil and fin system of claim 2, wherein the at least one hook comprises a plurality of hooks along a length of the at least one non-planar fin.

5. The integrated coil and fin system of claim 2, wherein the at least one hook comprises a hook at an end of each non-planar fin.

6. The integrated coil and fin system of claim 1, wherein the at least one coil comprises a hollow coil for guiding a fluid to flow therethrough.

7. The integrated coil and fin system of claim 6, wherein the fluid comprises a heating fluid or a coolant.

8. The integrated coil and fin system of claim 1, wherein the at least one non-planar fin has a first portion, and a second portion angled with respect to the first portion at an angle of approximately 90 degrees to approximately 180 degrees.

9. The integrated coil and fin system of claim 1, wherein the at least one non-planar fin comprises a plurality of non-planar fins, each non-planar fin in the plurality of non-planar fins attached to at least one coil.

10. The integrated coil and fin system of claim 1, wherein the at least one coil comprises a coil with a plurality of substantially parallel sections of the coil contacting the at least one non-planar fin.

11. The integrated coil and fin system of claim 1, wherein the at least one non-planar fin is attached to the at least one coil by ultrasonic soldering or hydraulic expansion.

12. A gas turbine inlet comprising:
a filter housing including an integrated coil and fin system, the system including:
at least one non-planar fin attached to at least one coil, wherein the at least one coil is configured to heat or cool air moving through the gas turbine inlet, and wherein the at least one non-planar fin is configured to remove moisture in the air moving through the gas turbine inlet; and
an inlet duct fluidly connected to the housing and to a gas turbine.

13. The gas turbine inlet of claim 12, wherein at least one non-planar fin includes at least one hook.

14. The gas turbine inlet of claim 13, wherein the at least one hook comprises an approximate half-ellipse shape.

15. The gas turbine inlet of claim 13, wherein the at least one hook comprises a plurality of hooks along a length of the at least one non-planar fin.

16. The gas turbine inlet of claim 13, wherein the at least one hook comprises a hook at an end of each non-planar fin.

17. The gas turbine inlet of claim 12, wherein the at least one coil comprises a hollow coil for guiding a fluid to flow therethrough, wherein the fluid comprises a heating fluid or a coolant.

18. The gas turbine inlet of claim 12, wherein the at least one non-planar fin has a first portion, and a second portion angled with respect to the first portion at an angle of approximately 90 degrees to approximately 180 degrees.

19. The gas turbine inlet of claim 12, wherein the at least one coil comprises a coil with a plurality of substantially parallel sections of the coil contacting the at least one non-planar fin.

20. The gas turbine inlet of claim 12, wherein the at least one non-planar fin is attached to the at least one coil by ultrasonic soldering or hydraulic expansion.
